(19) United States
(12) Patent Application Publication
(10) Pub. No.: US 2006/0048421 A1
(43) Pub. Date: Mar. 9, 2006

(54) Display board with header

(76) Inventor: Mark W. Oleksak, Indian Rocks Beach, FL (US)

Correspondence Address: CARLSON, GASKEY & OLDS, P.C., 400 WEST MAPLE ROAD, SUITE 350, BIRMINGHAM, MI, 48009, US

(21) Appl. No.: 10/933,757

(22) Filed: Sep. 3, 2004

(51) Int. Cl. G09F 15/00

(52) U.S. Cl. 40/610

(57) ABSTRACT

Display board has a first display panel and a second display panel. A first support layer supports the first display panel and the second display panel against flexing. A hinge extends along an axis and is formed from the support layer. The hinge permits the first display panel to pivot relative to the second display panel about the axis. A break is introduced in the support layer between the first display panel and the second display panel. The break is adjacent the hinge and extends along the axis.

### BACKGROUND OF THE INVENTION

This invention relates to a portable display board.

Display boards are frequently used to exhibit drawings, artwork, advertising, and other information at science fairs, trade shows, conferences, seminars, and other events. Frequently, these display boards are set up at a booth at such a gathering. Although the booth may be provided on site, it may be the case that both the booth and the display board must be transported by the presenter to the particular location. The booth can be very expensive. Consequently, a person giving presentations at a number of different locations must transport both the booth and the display board from location to location rather than leave them there.

While there are portable display boards, booths are typically made of heavy and durable materials. They are accordingly difficult to transport. Booths also require a fair amount of time to set up. There is thus a need for an inexpensive and easy to transport display board and booth.

### SUMMARY OF THE INVENTION

The invention works as both a portable display board and a booth. The board has an upper display section and a lower display section. Together, these sections are large enough to work like a backdrop of a booth. In addition, they have a surface upon which material may be appended or a message written to function as a display.

The upper display section has three upper display panels while the lower display section has three lower display panels. Each of the upper display panels are linked by a hinge that allows one display panel to pivot relative to another display panel. In this manner, the upper display panels may be folded relative to each other.

The lower display sections also have display panels with hinges. These hinges also allow the lower display panels to fold on top of each other. Moreover, there is another hinge linking the upper display section to the lower display section of the display board. This hinge permits the upper display section to fold relative to the lower display section. Accordingly, these hinges permit the display board to collapse into a small transportable form.

The display board has a folding stand and a header. The stand allows the board to support itself. The header both stabilizes the display board and also provides a display surface similar to a banner of a booth. These features further help the display board to work like a booth.

The entire board may be made from an inexpensive material, such as corrugated cardboard. Indeed, even the hinges may be formed from this material. As a consequence, the display board is inexpensive to produce as well as light to ship. The display board is disposable and may be left at the site of the presentation.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 illustrates the inventive display board, showing display panels and hinges with header mounted on display board.

FIG. 2 illustrates display board of FIG. 1 with header disassembled from the display board.

FIG. 3 illustrates the display board of FIGS. 1-2 folded.

FIG. 4 illustrates a step in the folding of the display board of FIGS. 1-3.

FIG. 5 illustrates a behind view of the display board of FIGS. 1-4, highlighting a stand attached to the display board in the extended position.

FIG. 6 illustrates a stand of FIG. 5 in the folded position.

FIG. 7 illustrates a close up view of a hinge of the display board of FIGS. 1-6.

FIG. 8 illustrates another hinge of the display board of FIGS. 1-6.

FIG. 9 illustrates a cross-sectional view of the hinge of FIG. 7.

FIG. 10 illustrates a cross-sectional view of the hinge of FIG. 8.

FIG. 11 illustrates a cross-sectional view of another hinge.

FIG. 12 illustrates a cross-sectional view of a break of the display board.

### DETAILED DESCRIPTION OF THE PREFERRED EMBODIMENT

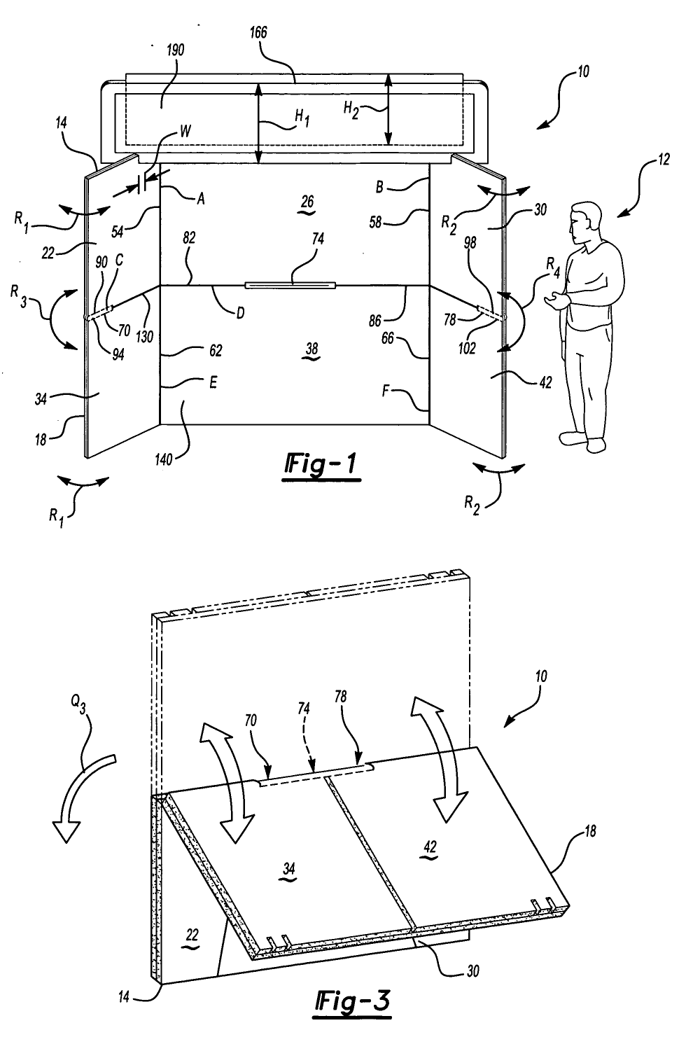

FIG. 1 illustrates the inventive portable display board 10 fully assembled. As shown, portable display board 10 has upper display section 14 and lower display section 18. Upper display section 14 has three panels: first display panel 22, second display panel 26 and third display panel 30. Lower display section 18 also has three panels: fourth display panel 34, fifth display panel 38 and sixth display panel 42. Each of these display panels is made from two layers of corrugated cardboard, which form first support layer 46 and second support layer 50 as shown in FIGS. 9 and 10. First support layer 46 and second support layer 50 support each of the foregoing display panels 22, 26, 30, 34, 38 and 42 against flexing. That is, although each of these panels may be bent or folded, there is sufficient rigidity provided by first support layer 46 and second support layer 50 to provide resistance against folding and flexing of each display panel. Although two support layers are shown, display board 10 may also be constructed from only one support layer or more than two support layers. In addition, each display panel also has a side with craft paper 190, such as a white craft paper as shown in FIGS. 9 and 10, to permit a user to write on the surface of each display panel.

As shown in FIG. 1, upper display section 14 and lower display section 18 when fully assembled is large enough to act as a booth for presenter 12. Of course, the size of each panel and the overall size of display board 10 may be increased or decreased to suit any particular purpose or accommodate any size individual. Display board 10 has hinges that permit the display panels to be folded relative to each other. As shown in FIG. 1, first display panel has first hinge 54 that permits first display panel to pivot relative to second display panel 26 about axis A along arc R₁. Moreover, second display panel 26 is hingidly attached by second hinge 58 to third display panel 30, thereby permitting third display panel 30 to pivot along axis B relative to second display panel 26 along arc R₂. For lower display section 18, there is third hinge 62 that permits fourth display panel 34 to pivot relative to fifth display panel 38 about axis E along arc R₁. Fifth display panel 38 is also hingidly attached to sixth display panel 42 by fourth hinge 66, which permits sixth display panel 42 to pivot along arc R₂ about axis F.

In addition, there are also hinges that permit display panels of upper display section 14 to fold relative to display panels of lower display section 18. In this regard, fifth hinge 70 permits first display panel 22 to fold over fourth display panel 34 along arc R₃ about third axis C. Similarly, third display panel 30 may fold relative to sixth display panel 42 through seventh hinge 78 about seventh axis G along arc R₄. There is also provided sixth hinge 74 that permits second display panel 26 to fold relative to fifth display panel 38 about fourth axis D. As will be seen, these hinges permit display board 10 to fold to a dimension less than half its overall size for easy transportation.

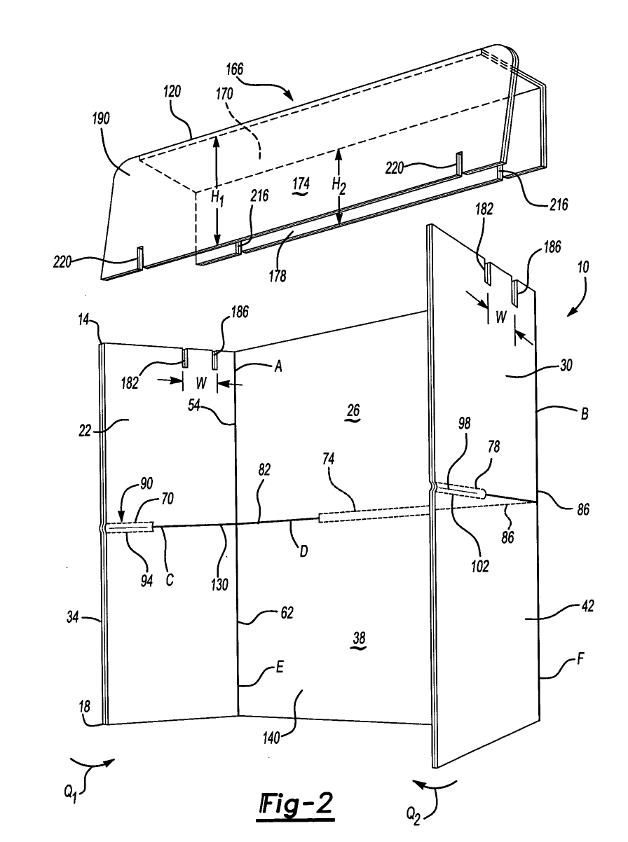

As shown in FIG. 2, portable display board 10 has header 166 also made of first support layer 46 and second support layer 50. Header 166 also has craft paper 190 to permit information to be written on its surface and provides a banner surface for display board 10 to function as a booth. Header 166 has folds 170 that divide header into first section 174 and second section 178. Accordingly, first section 174 may fold relative to second section 178 so that header 166 may be attached to portable display 10 by first attachment feature 182, such as a slot, and second attachment feature 186, such as another slot. Each slot is a notch through first support layer 46 and second support layer 50. Hence, first section 174 is received by two first attachment features 182 while second section 178 is received by two second attachment features 186. Slot 182 is spaced from slot 186 on first display panel 22 and on third display panel 30 by a width, W. Because of the spacing of these attachment features, header 166 is stabilized at four different points, at each attachment feature 182, 186.

Also, header 166 is provided with additional attachment features, third attachment features 216 and fourth attachment features 220. Both attachment features are also slots in both first support layer 46 and second support layer 50. Third attachment features 216 are sized to engage second attachment features 186 while fourth attachment features 220 are sized to receive first attachment features 182 so that the slots interlock. In this way, header 166 acts to prevent first display panel 22 and fourth display panel 34 from folding onto second display panel 26 and fifth display panel 38, respectively, when these attachment features are engaged. Similarly, third display panel 30 and sixth display panel 42 are also prevented from folding onto panels 26 and 38, respectively. Thus, header 166 locks these panels in place, providing a stable self-supporting display board. Also, header 166 may be angled relative to ground to alter the viewing angle of first section 174. For example, first section 174 may have a greater height H₁ than the height H₂ of second section 178 so that first section 174 is angled upward.

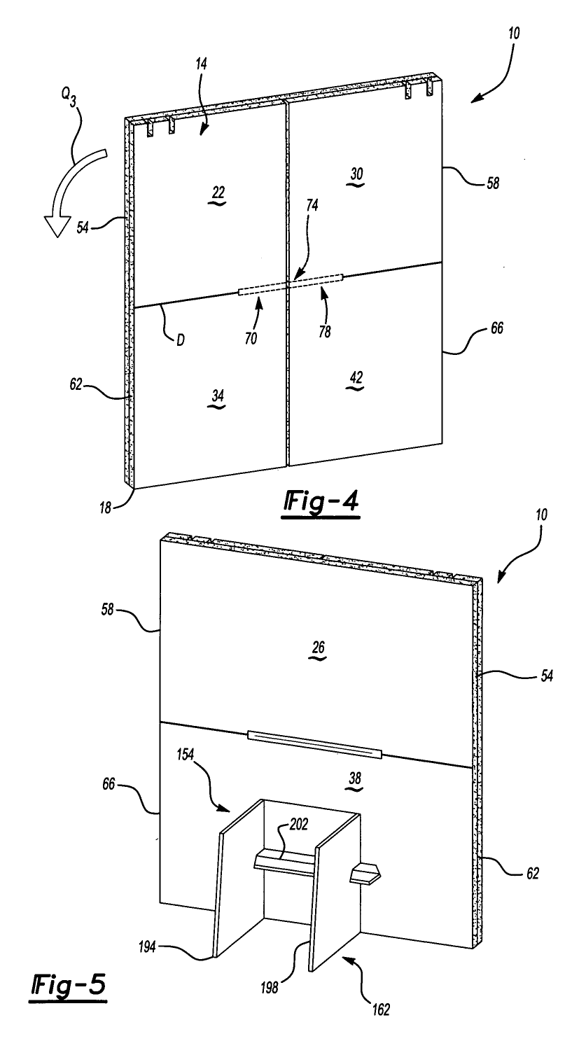

The folding and disassembly of portable display board 10 will now be demonstrated with reference to FIGS. 2-6. To disassembly portable display 10, header 166 is removed from first attachment features 182 and second attachment features 186. Then, as shown in FIG. 2, first display panel 22 and fourth display panel 34 are folded toward second display panel 26 and fifth display panel 38 along the direction of arrow Q₁. Because these panels 22 and 34 are attached by hinge 70, they will fold together. Similarly, third display panel 30 and sixth display panel 42 are folded over second display panel 26 and fifth display panel 38 in the direction of Q₂ about second hinge 58 and fourth hinge 66, respectively. Again, through hinge 78, these panels will fold together. When these panels have been folded in this manner, display board will look as shown in FIG. 4. Upper display section 14 may then be folded over lower display section 18 in the direction of arrow Q₃ through hinge 74 to a position shown in FIG. 3 where upper display section 14 is folded over lower display section 18. In this position, first hinge 70 and seventh hinge 78 are disposed over sixth hinge 74. Portable display 10 may be unfolded and assembled using opposite steps as described above.

As shown, first display panel 22 and third display panel 30 are sized to permit them to fold over second display panel 26. First display panel may be about equal width as third display panel 30 so that when these display panels are folded, they lay flat against second display panel 26. Fourth display panel 34 and sixth display panel 42 may also be similarly sized so that they may fold over fifth display panel 38 and lay flat against fifth display panel 38.

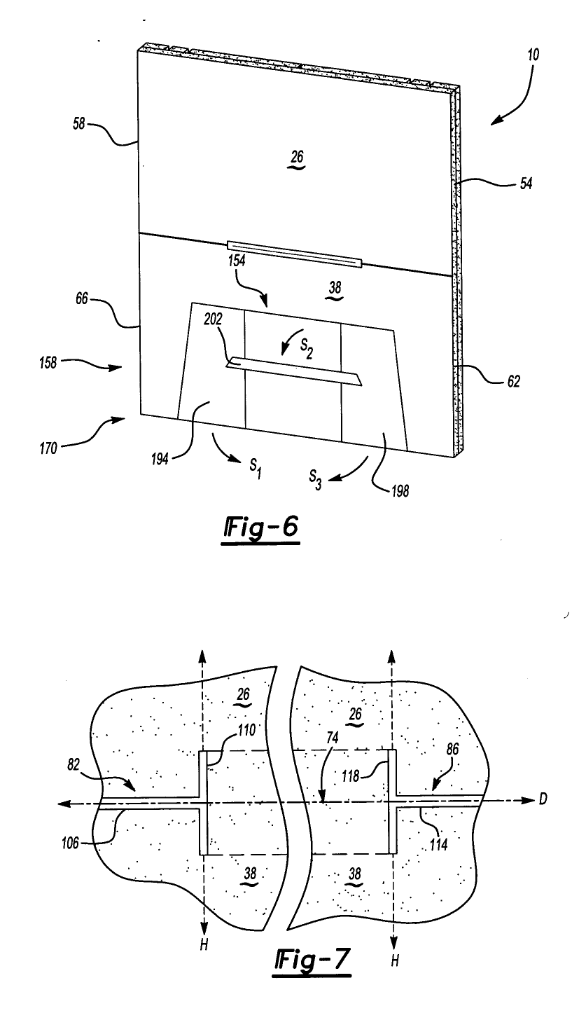

FIGS. 5 and 6 show another feature of portable display 10. FIG. 5 shows stand 154 in an unfolded or extended position 162 while FIG. 6 shows stand 154 folded. Stand 154 is attached to fifth display panel 38 by an adhesive or other known attachment mechanism. Stand 154 is also made of corrugated cardboard, such as a two layer corrugated cardboard. Stand 154 provides additional lateral stability to portable display 10.

As shown in FIG. 6, stand 154 may also be folded and transported with portable display 10. From the folded position 170, stand 154 has flaps 194, 198 and 202. Flap 194 may be extended in the direction of arrow S₁ from fifth display panel 38. Also, flap 198 may be extended from fifth display panel 38 in the direction of arrow S₃. Then, flap 202 is extended in the direction of arrow S₂ to lock flaps 194 and 198 in the extended position 162 shown in FIG. 5. Stand 154 may be folded by following the foregoing steps in reverse order.

FIGS. 7-11 show various views of the hinges of portable display 10. These hinges are formed from first support layer 46 and second support layer 50. FIG. 7 illustrates sixth hinge 74, the hinge connecting second display panel 26 to fifth display panel 38. Sixth hinge 74 is formed of first support layer 46 and second support layer 50. As mentioned before, first support layer 46 and second support layer 54 are normally rigid enough to support each display panel. However, this material, such as cardboard, is also foldable. To facilitate folding about sixth hinge 74, first break 82 and second break 86 are provided. As shown in FIG. 12, first break 82 is formed by a cut through first support layer 46 and second support layer 50. Break 86 is similarly formed. While FIG. 12 shows break 82 formed by cutting through both first support layer 46 and second support layer 50, a partial cut through one layer or both layers may suffice to weaken the area around hinge 74 so that second display panel 26 may fold easily relative to fifth display panel 38.

Also, as shown in FIG. 7, break 82 is formed from first break line 106 and second break line 110, both break lines may be full or partial cuts through one support layer or multiple support layers. Similarly, break 86 has third break line 114 and fourth break line 118 formed in similar fashion. Notably, first break line 106 and third break line 114 extend along axis D, thereby facilitating the pivoting of second display panel 26 relative to fifth display panel 38. Second break line 110 and fourth break line 118 extend along axis H, an axis transverse (here orthogonal) to axis D. Second break line 110 and fourth break line 118 further help second display panel 26 to fold relative to fifth display panel 38 and redirect tearing forces that may travel across break 106 and 114 along axis D to the direction of axis H, thereby providing a more tear resistant hinge. As shown in FIGS. 1 and 2, break 82 extends between sixth hinge 74 and fifth hinge 70 while break 86 extends between sixth hinge 74 and seventh hinge 78.

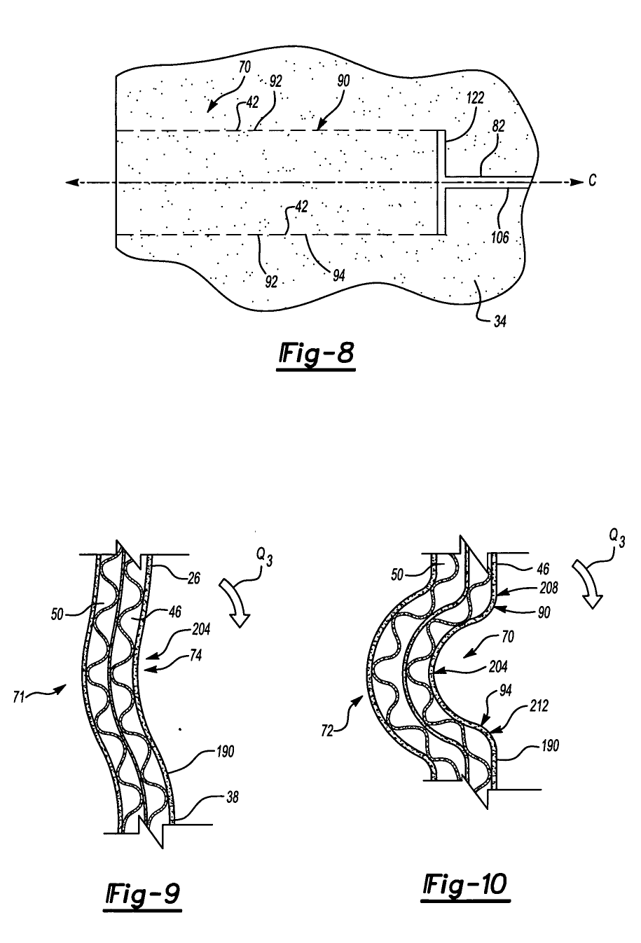

A close up of fifth hinge 70 is shown in FIG. 8. Seventh hinge 78 is formed in identical fashion to fifth hinge 70. As shown in FIG. 8, fifth hinge 70 is adjacent first break 82 and first break line 106 and further has fifth break line 122 that extends through first support layer 46 and second support layer 50. Fifth hinge 70 is also formed from first support layer 46 and second support layer 50 and permits first display panel 22 to pivot relative to fourth display panel 34 about axis C. In addition, fifth hinge 70 is provided with breaks 90 and 94, here, perforations 92, that extend through first support layer 46 and second support layer 50. These perforations permit first support layer 46 and second support layer 50 to fold at each break 90 and 94.

The difference between sixth hinge 74 and fifth hinge 70 will be shown with reference to FIGS. 9 and 10. As shown in FIG. 9, sixth hinge 74 has fold 204 that permits second display panel 26 to fold in the direction of arrow Q₃ relative to fifth display panel 38. As shown in FIG. 10, fifth hinge 70 has third break 90 and fourth break 94. Accordingly, unlike sixth hinge 74 of FIG. 9, fifth hinge 70 forms folds 208, 204 and 212, thereby creating a larger bow 72 than bow 71 shown in FIG. 9. This bow 72 allows fifth hinge 70 as well as seventh hinge 78 to fold over sixth hinge 74 more easily when display board 10 is folded to the configuration shown in FIG. 3.

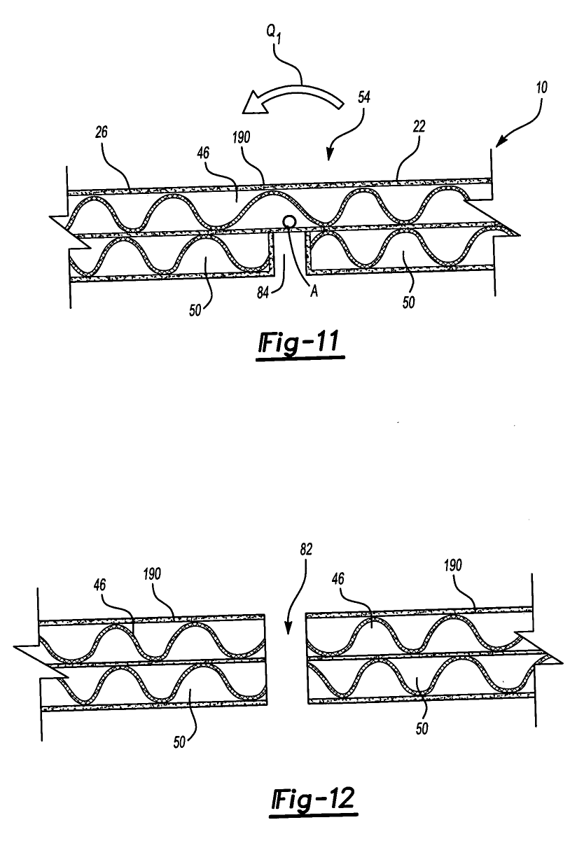

FIG. 11 illustrates how first hinge 54, second hinge 58, third hinge 62 and fourth hinge 66 are formed. FIG. 11 shows an above view of portable display 10. First hinge 54 is shown for illustration purposes although second hinge 58, third hinge 62 and fourth hinge 66 are formed in similar fashion. First hinge 54 is formed by creating a break 84 in second support layer 50. By creating this break, only first support layer 46 holds first display panel 22 to second display panel 26. Because second support layer 50 has break 84, first display panel 22 may pivot about axis A in the direction of arrow Q₁ relative to second display panel 26.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

What is claimed is:

1. A display board comprising:
a first display panel;
a second display panel;
a first support layer forming said first display panel and said second display panel, said first support layer supporting said first display panel and said second display panel against flexing;
a first hinge extending along a first axis and formed from said first support layer, said first hinge for permitting said first display panel to pivot relative to said second display panel about said first axis; and
a first break in said first support layer between said first display panel and said second display panel, said first break adjacent said first hinge and extending along said first axis.

2. The display board of claim 1 wherein said first break comprises a first break line and a second break line, said first break line extending generally along said first axis and said second break line extending along a second axis transverse to said first axis.

3. The display board of claim 2 wherein said second break line extends across said first display panel and said second display panel.

4. The display board of claim 1 wherein said first break extends over a substantial portion of a border shared between said first display panel and said second display panel.

5. The display board of claim 4 wherein said first break extends along said first axis over one quarter of said border.

6. The display board of claim 1 wherein said first support layer comprises corrugated cardboard.

7. The display board of claim 1 wherein said first break extends at least partially through said first support layer along said first axis.

8. The display board of claim 1 including a second break extending generally along said first axis and adjacent said first hinge, said first break on one side of said first hinge and said second break on the other side of said first hinge.

9. The display board of claim 1 including a second hinge spaced along said first axis from said first hinge, said first break extending between said first hinge and said second hinge.

10. The display board of claim 1 wherein said first hinge has a second break extending along a second axis spaced from said first axis and generally parallel to said first axis.

11. The display board of claim 10 wherein said first hinge has a third break extending along a third axis spaced from said first axis and said second axis and generally parallel to said first axis.

12. The display board of claim 1 including a stand attached to one of said first display panel and said second display panel, said stand having a folded position and an unfolded position, said stand extending from said one of said first display panel and said second display panel in said unfolded position.

13. A display board comprising:
an upper display section having a first upper display panel, a second upper display panel, a third upper display panel;
said first upper display panel and said third upper display panel hingedly attached to said second upper display panel, said first upper display panel pivotable relative to said second upper display panel along a first hinge axis and said third upper display panel pivotable relative to said second upper display panel along a second hinge axis, said first hinge axis generally parallel to said second hinge axis a lower display section having a first lower display panel, a second lower display panel, a third lower display panel;
said first lower display panel and said third lower display panel hingedly attached to said second lower display panel, said first lower display panel pivotable relative to said second lower display panel along a third hinge axis and said third lower display panel pivotable relative to said second lower display panel along a fourth hinge axis, said third hinge axis generally parallel to said fourth hinge axis; and
wherein said upper display section is hingedly attached to said lower display said upper display section pivotable relative to said lower display section along a fifth hinge axis, said fifth hinge axis transverse to at least one of said first hinge axis, said second hinge axis, said third hinge axis and said fourth hinge axis.

14. The display panel of claim 13 wherein said upper display section and said lower display section comprise a corrugated cardboard.

15. The display panel of claim 14 including a connecting hinge connecting said upper display section to said lower display section, said connecting hinge formed from said corrugated cardboard.

16. The display panel of claim 15 including a break adjacent said connecting hinge and separating said upper display section from said lower display section, said break extending along said fifth axis.

17. The display panel of claim 16 wherein said connecting hinge comprises a first connecting hinge, a second connecting hinge and a third connecting hinge, said first connecting hinge attaching said first upper panel to said first lower panel, said second connecting hinge attaching said second upper panel to said second lower panel, and said third connecting hinge attaching said third upper panel to said third lower panel.

18. The display panel of claim 17 wherein said break comprises a first break line and a second break line, said first break line extending between said first connecting hinge and said second connecting hinge and said second break line extending between said second connecting hinge and said third connecting hinge.

19. The display panel of claim 13 including a header disposed on said upper display section, said header having a fold that divides said header between a first section and a second section, said first section engaging a first attachment feature on said upper display section and said second section engaging a second attachment feature on said upper display section.

20. A portable display comprising:
a first display panel, a second display panel, and a third display panel;
said first display panel hingedly attached to said second display panel by a first hinge, said first display panel pivotable relative to said second display panel about a first hinge axis;
said second display panel hingedly attached to said third display panel by a second hinge, said second display panel pivotable relative to said third display panel about a second hinge axis, said first hinge axis transverse to said second hinge axis; and
a break between said first display panel and said second display panel, said break adjacent said first hinge and extending along said first hinge axis.
